(19) United States
(12) Patent Application Publication
(10) Pub. No.: US 2011/0231896 A1
(43) Pub. Date: Sep. 22, 2011

(54) SYSTEMS AND METHODS FOR REDIRECTION OF ONLINE QUERIES TO GENUINE CONTENT

(76) Inventor: Tom C. Tovar, San Francisco, CA (US)

(21) Appl. No.: 12/897,659

(22) Filed: Oct. 4, 2010

Related U.S. Application Data
(63) Continuation-in-part of application No. 12/727,001, filed on Mar. 18, 2010.
(60) Provisional application No. 61/370,556, filed on Aug. 4, 2010.

(51) Int. Cl. G06F 21/00

(52) U.S. Cl. 726/1

(57) ABSTRACT

A system for redirection of online queries to a genuine content includes a user interface module to provide a user interface between a network user with administrative authority and an Internet service, a communication module to receive a request to establish a genuine content resolution policy for a network, a policy generating module to establish the genuine content resolution policy for the network, and a policy enforcement module to apply the genuine content resolution policy to a user request to access an intended website. The policy enforcement module may determine whether or not the genuine content resolution policy is activated, determine whether or not that the intended website is the genuine website, and based on the determination, selectively redirect the user to the genuine website.

### CROSS-REFERENCE TO RELATED APPLICATIONS

This nonprovisional patent application is a continuation-in-part application that claims the priority benefit of U.S. patent application Ser. No. 12/727,001 filed on Mar. 18, 2010, titled “Internet Mediation,” and provisional U.S. Patent Application Ser. No. 61/370,556, filed on Aug. 4, 2010, titled “Internet Mediation Applications,” which are hereby incorporated by reference in their entirety.

### FIELD OF THE INVENTION

This application relates generally to data processing and more specifically to systems and methods for redirection of online queries to genuine content.

### BACKGROUND

Cybersquatting has been a growing problem since the advent of the Internet. Cybersquatters typically register and use a domain name with bad faith intent to benefit from the good will of other persons or organizations. Cybersquatters may put up derogatory or false remarks about the person or organization the domain is meant to represent.

Typosquatting is a form of cybersquatting which relies on mistakes such as typographical errors made by Internet users when inputting a website address into a web browser. Should a user accidentally enter an incorrect website address, they may be led to an alternative website owned by a typosquatter. Once in the typosquatter's website, the user may also be tricked into thinking that they are in fact in the intended site through the use of logos, website layouts, or content similar to that used in the intended site. Thus, cybersquatting or typosquatting websites may serve as masks for phishing websites, the sites can confuse users, and they can be a frustrating interference in the path of reaching the intended destination.

Currently, many Internet browsers include auto-resolution mechanisms. These solutions may provide suggested websites based on bidding mechanisms in the same manner as search results are listed. However, there is currently no technological solution available to the user should the user be exploring an unfamiliar Internet content. Thus, in order to access genuine Internet content, users must type a correct query, find a link that will take them to the correct website, or use a search page to find their desired website.

### SUMMARY OF THE INVENTION

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In an exemplary embodiment, systems and methods for redirection of online queries to a genuine content may include using a user interface between a network user with administrative authority and an Internet service to receive a request to establish a genuine content resolution policy, and applying the genuine content resolution policy to a user request to access a website. The network user parameters associated with the genuine content resolution policy may be accessible by the network user with administrative authority through a configuration webpage. The user interface may also provide a mechanism for activating and deactivating the genuine content resolution policy. The determination as to whether or not the genuine content resolution policy is in effect to provide the genuine website instead of the intended website may include determining whether or not the genuine content resolution policy is activated and whether or not the intended website is the genuine website.

In an exemplary embodiment, systems and methods for redirection of online queries to a genuine content may include maintaining a list of frequently accessed websites. The genuine content resolution policy may be based on this list of frequently accessed websites.

In an exemplary embodiment, systems and methods for redirection of online queries to a genuine content may include compiling data related to the genuine content resolution policy in a reporting log, with the log including the intended website, a number of requests to access the intended website, and the genuine website corresponding to the intended website. The determination as to whether or not the intended website is the genuine website may be based on spelling mistakes in the intended website or on the ownership of the intended website.

In further exemplary embodiments, the steps of the above methods may be stored on a computer readable storage medium having a program embodied thereon, the program executable by a processor in a computing device. In yet further exemplary embodiments, modules, subsystems, or devices can be adapted to perform the recited steps. Other features and exemplary embodiments are described below.

### BRIEF DESCRIPTION OF THE DRAWINGS

Exemplary embodiments are illustrated by way of example and not limitation in the figures of the accompanying drawings, in which like references indicate similar elements.

FIG. 1 is a block diagram of a genuine content resolution engine, in accordance with various embodiments of the present technology.

FIG. 2 illustrates a flow chart of a method for redirection of online queries to genuine content.

FIG. 3 is a screenshot of a description associated with a genuine content resolution application.

FIG. 4 is a screenshot of a configuration webpage associated with a genuine content resolution application.

FIG. 5 is a block diagram of a Domain Name Server (DNS) environment.

FIG. 6 is a block diagram of a system within which a genuine content resolution policy may be implemented.

FIG. 7 is a computing system that may be used to implement the methods for redirection of online queries to genuine content.

### DETAILED DESCRIPTION

Systems and methods for redirection of online queries to genuine content, in some exemplary embodiments, may be utilized to refuse Internet service resolution attempts to typosquatting and domain squatting sites, and instead redirect users to their intended web destinations despite typing an associated misspelling into the browser. This approach may reduce or eliminate the intrusion of typosquatting and domain squatting sites into the user experience.

The systems and methods for redirection of online queries to genuine content may be applied to the common misspellings of the frequently visited websites (e.g., financial service, consumer retail, and social networking sites). For example, a user may be redirected to the legitimate celebrity or public figure website, even if an unauthorized third party already registered a website containing the respective celebrity name (e.g., www.madonna.com).

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

Generally speaking, a network user with administrative authority may create and enforce content resolution polices for one or more end users that utilize computing devices coupled to an Internet service delivered to a location such as a home, residence place of business or campus. The term “administrator” may include not only individuals, such as parents, but also any individual creating content resolution policies regarding the Internet service delivered to end users. It will be understood that an administrator may also be an end user, although end users who are not also administrators may not create or apply redirection policies.

It will be further understood that because of the diversity of computing devices that may connect to the Internet service, the content resolution policy may be applied to the Internet service rather than requiring the content resolution policy to affect each computing device individually, such as a redirection application resident on each computing device. In various exemplary embodiments a content resolution policy may also reside as a stand alone application on one or more of the computing devices.

Exemplary user devices for use with the disclosed systems may have a user interface. In various embodiments, such as those deployed on personal mobile devices, the user interface may be, or may execute, an application, such as a mobile application (hereinafter referred to as an “app”). An app may be downloaded and installed on a user's mobile device. Users may define a mediation policy via a user device, such as through the user interface. Some embodiments of the present invention do not require software to be downloaded or installed locally to the user device and, correspondently, do not require the user to execute a de-install application to cease use of the system.

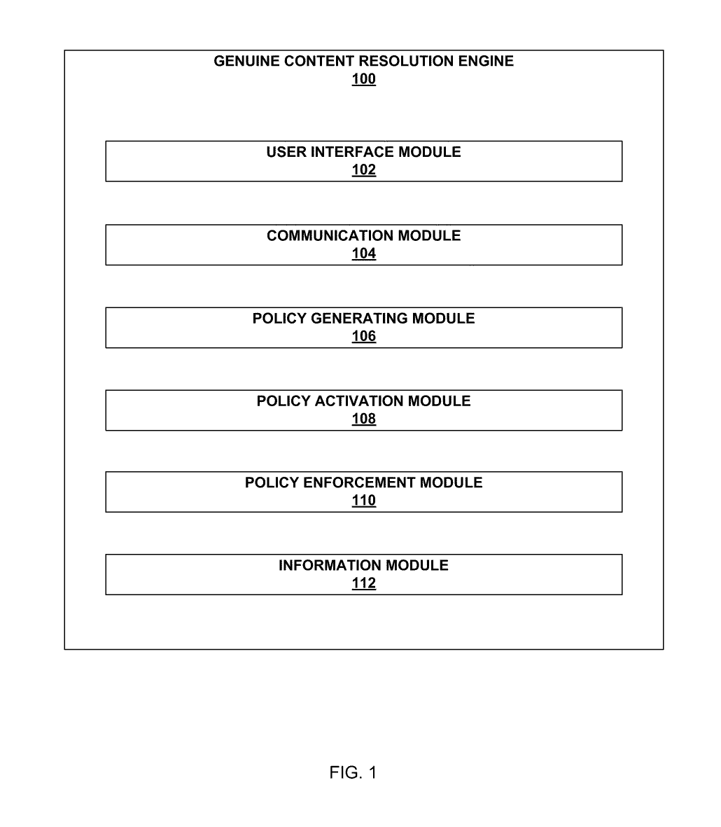

FIG. 1 is a block diagram of a genuine content resolution engine 100, in accordance with various exemplary embodiments of the technology. Alternative embodiments of the genuine content resolution policy system may comprise more, less, or functionally equivalent modules. In some exemplary embodiments, the genuine content resolution engine 100 comprises a user interface module 102, a communication module 104, a policy generating module 106, a policy activation module 108, a policy enforcement module 110, and an information module 112. It will be appreciated by one of ordinary skill that examples of the foregoing modules may be virtual, and instructions said to be executed by a module may, in fact, be retrieved and executed by a processor. The foregoing modules may also include memory cards, servers, and/or computer discs. Although various modules may be configured to perform some or all of the various steps described herein, fewer or more modules may be provided and still fall within the scope of various embodiments.

The user interface module 102 may be configurable to establish the user interface 610, which may be utilized by a network user 560 with administrative authority at the user device 550. The user interface 610 may include a brief application description and one or more configuration prompts permitting the network user 560 with administrative authority to activate and deactivate the genuine content resolution policy, for example, by using ON and OFF buttons.

The communication module 104 may be configurable to provide a communication channel between the various components of the genuine content resolution engine 100 and the user interface 610. Additionally, the communication module 104 may enable the direct exchange of information between various modules of the genuine content resolution engine 100. For example, the communication module 104 may facilitate receiving activation and deactivation requests provided by the network user 560 with administrative authority via the user interface 610.

The network user 560 with administrative authority may wish to create the genuine content resolution policy to prevent cybersquatting, such as domain squatting and/or typosquatting. The genuine content resolution policy may be applied to any request received within the DNS Network 540. When there is a misspelling in the intended website or the intended website is no longer owned by the proper entity, the policy enforcement module 110 may resolve the request to a genuine website. Thus, systems and methods for redirection of online queries to genuine content may automatically redirect online requests to a proper site, leaving cybersquatters with no financial leverage in possessing the domain name.

In some exemplary embodiments, clicking ON or OFF buttons will not automatically activate or deactivate the genuine content resolution policy. Therefore, to active or deactivate the genuine content resolution policy, network user 560 with administrative authority may need to take an explicit action (e.g., clicking the OK button). The policy activation module 108 may be utilized any time the network user 560 with administrative authority decides to terminate the genuine content resolution policy.

In some exemplary embodiments, the network user 560 with administrative authority may not need to take any affirmative action to activate the genuine content resolution policy. Instead, the genuine content resolution policy may be activated by default once the network user 560 with administrative authority has deployed the application 620 at the DNS network 540. Alternatively, in some exemplary embodiments, the application 620 may be preinstalled at the DNS network 540 (whether activated or not).

Once the genuine content resolution policy is activated and the network user 560 attempts to access an intended website, the policy enforcement module 110 may determine whether or not the intended website is a genuine website. Upon such determination, the policy enforcement module 110 may enforce the genuine content resolution policy by redirecting access from the intended website to the genuine website. Data relative to access attempts and also to redirects may be recorded and prepared for reporting by the information module 112.

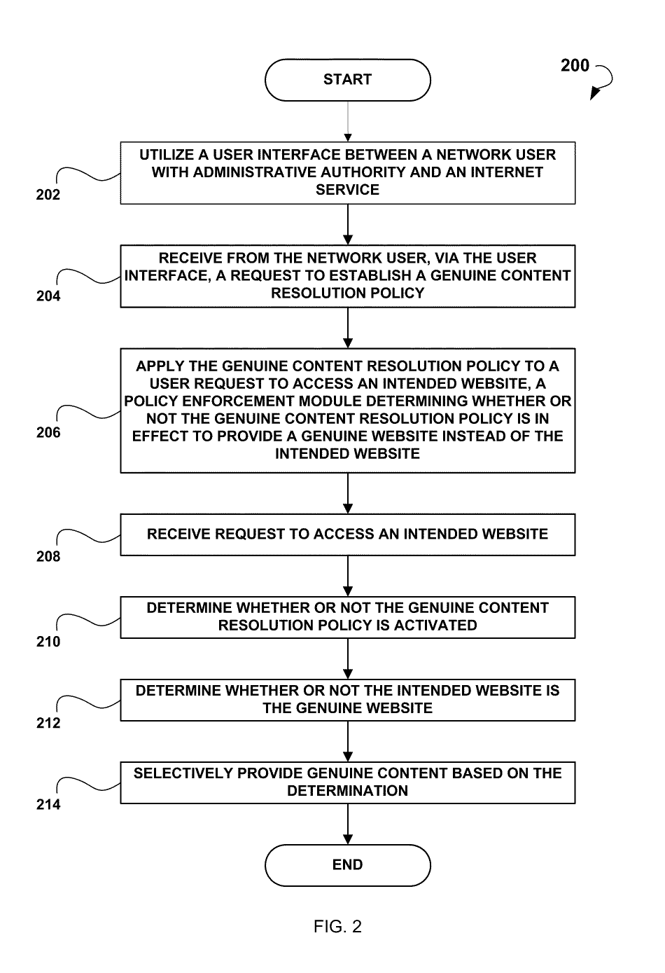

FIG. 2 illustrates a flow chart of a method 200 for redirection of online queries to genuine content, in accordance with an exemplary embodiment. The method 200 may be performed by processing logic that may comprise hardware (e.g., dedicated logic, programmable logic, microcode, etc.), software (such as run on a general-purpose computer system or a dedicated machine), or a combination of both. In one exemplary embodiment, the processing logic resides at the genuine content resolution engine 100, as illustrated in FIG. 1.

The method 200 may be performed by the various modules discussed above with reference to FIG. 1. Each of these modules may comprise processing logic. The method 200 may commence at operation 202 with the user interface module 102 establishing the user interface 610 between the network user 560 with administrative authority and the DNS network 540. Using the user interface 610, the network user 560 with administrative authority may activate or deactivate the genuine content resolution policy.

Using the user interface 610, the network user 560 with administrative authority may save configuration parameters for the genuine content resolution policy (e.g., by clicking the OK button). Thus, at operation 204, the communication module 104 may facilitate receiving a request from the network user 560 with administrative authority to establish the genuine content resolution policy. The request may be accompanied by parameters associated with the genuine content resolution policy. The parameters may be accessible by the network user 560 with administrative authority through a configuration webpage.

At operation 206, the policy enforcement module 110 may apply the genuine content resolution policy to a network user request to access an intended website. The policy enforcement module may determine whether or not the genuine content resolution policy is in effect to provide a genuine website, instead of the intended website.

At operation 208, the communication module 104 may receive a request to access an intended website. However, the website may be a website owned by a cybersquatter. To determine whether or not the intended website is a genuine website, the genuine content resolution engine 100 may maintain a substitution list of the most frequently accessed websites. Each Internet site on the substitution list may be assigned a confidence score to assist in determining the intended Internet site. Various techniques, such as regression analysis, etc., may be used to adjust the confidence scores, and to increase the probability of redirection to the intended site. The genuine content resolution policy may be based on the list of the most frequently accessed websites. If the intended website is one of the most frequently used websites, it may be established as a genuine website. Additionally, the determination as to whether or not the intended website is the genuine website may be based on one or more spelling mistakes in the intended website and/or on an ownership of the intended website. A substitution list may also be maintained by the Internet service.

Administrator-defined Internet content may also include Internet content collaboratively determined by a group of end users invited by the administrator to collaborate on the relevance of Internet content used in the mediation policy. The administrator may, before or after the administrator creates the administrator's own content resolution policy, invite the administrator's family members, friends, colleagues or any group of combination of groups and individuals to identify appropriate Internet content to be used by the administrator in creating the administrator's own content resolution policy. These invitees may or may not be users of the Internet service but will be allowed to contribute to the administrator's content resolution policy via the user interface of the Internet service. The administrator may choose to moderate the contributions of individuals or groups invited by the administrator to contribute to the administrator's content resolution policy. The administrator may also, before or after the administrator creates the administrator's own content resolution policy, join an existing group of users of the Internet service and apply the determinations of relevant of Internet content by a group to the administrator's own content resolution policy. Where there is an existing group that the administrator joins for purposes of creating a content resolution policy, the administrator may choose to import the contributions of other groups once or subscribe to these groups to reduce the configuration burden of creating a content resolution policy. After the administrator creates the administrator's own content resolution policy, the administrator may publish the administrator's content resolution policy to be used and/or subscribed to by other users of the Internet service. In such case, other users of the Internet service may import the contributions of administrator once or subscribe to the administrator's content resolution policy for use in their own content resolution policies. It is understood that via this collaboration two or more user-administrators may combine their content resolution policies to create one content resolution policy that may be used by these and other administrators of the Internet service.

At operation 210, the policy enforcement module 110 may determine whether or not the genuine content resolution policy is activated. If the genuine content resolution policy is activated, at operation 212, the policy enforcement module 110 may determine whether or not the intended website is the genuine website. If the genuine content resolution policy is activated and the website is the genuine website, at operation 214 the policy enforcement module 110 may provide the genuine content. The data related to the genuine content resolution policy may be compiled in a reporting log by the information module 112. Data recorded may include the data related to the intended website, a number of requests to access the intended website, and the genuine website corresponding to the intended website.

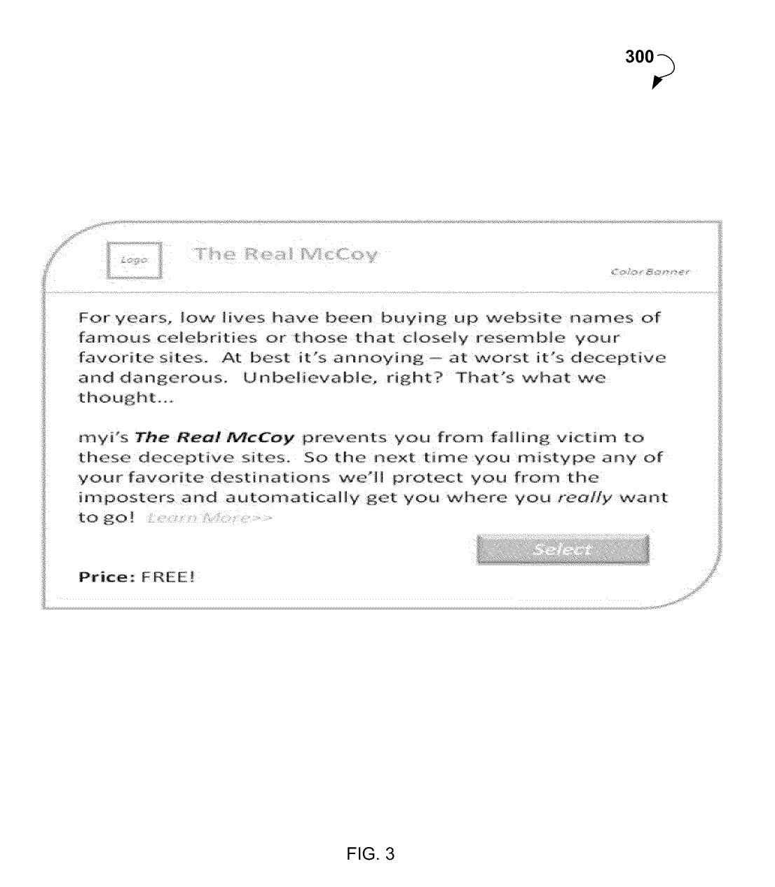

FIG. 3 is a screenshot of a description 300 associated with a genuine content resolution policy application, in accordance with an exemplary embodiment. The description 300 may generally describe what cybersquatting is and what the genuine content resolution policy does. As shown in FIG. 3, the description 300 may begin with one or more sentences describing the functionality of the genuine content resolution policy. In some exemplary embodiments, the description 300 may outline steps in activating and deactivating the genuine content resolution policy.

For example, the first paragraph may describe a scenario where an Internet user falls for a phishing scam. This example may show how easy it is for a user to fall victim to a standard phishing trick without even realizing it. The second paragraph may provide a brief summary of the security application's functionality. The description 300 may also include a “Learn More” link that may allow the network user 560 to receive more detailed information about the genuine content resolution policy application.

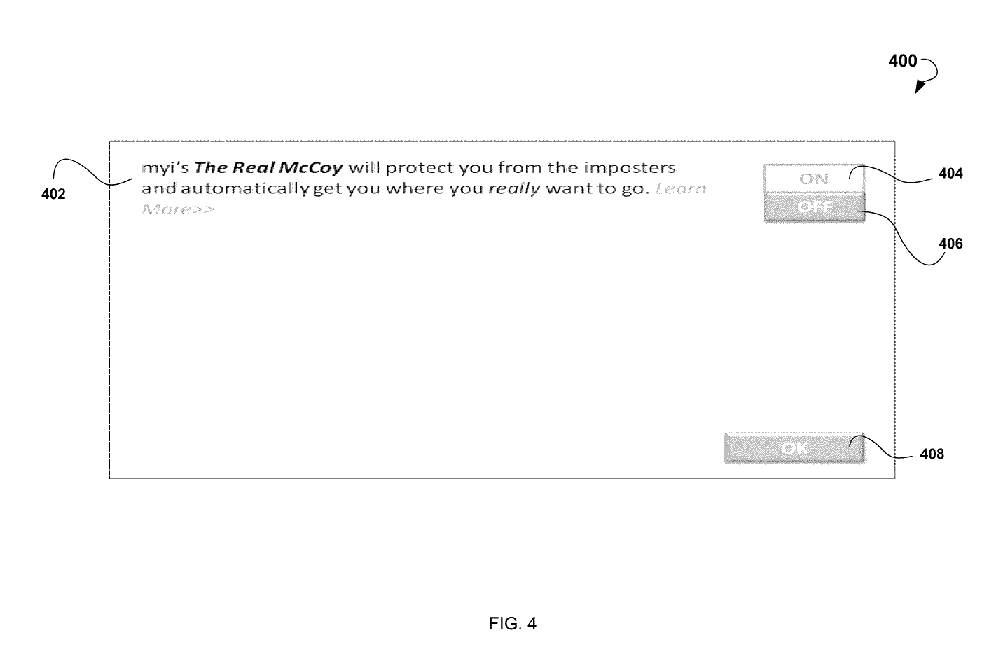

FIG. 4 is a screenshot of a configuration webpage 400. In some exemplary embodiments, the configuration webpage 400 may comprise a description text 402, an “ON” button 404, an “OFF” button 406, and an “OK” button 408. Configuration parameters associated with the genuine content resolution policy may be accessible through the configuration webpage 400.

As shown in FIG. 4, the network user 560 with administrative authority may choose to turn the genuine content resolution policy on by clicking the “ON” button 404. By turning the security application on, the network user 560 with administrative authority is directing the genuine content resolution engine 100 to determine whether or not the intended website is the genuine website. If the network user 560 with administrative authority wishes to disable the genuine content resolution policy, he can do so by clicking the “OFF” button 406. As a result of disabling the genuine content resolution policy, network users may be left unprotected from cybersquatting websites.

The network user 560 with administrative authority may alter these settings at any time. In some exemplary embodiments, the network user 560 with administrative authority may click the “ON” button 404 or the “OFF” button 406. The network user 560 with administrative authority may not be provided with the option of creating a partial or customized list of website redirections. Instead the genuine content resolution engine 100 may make an appropriate determination. In addition to turning the genuine content resolution policy on, the network user 560 with administrative authority may need to click the “OK” button 408 to have the genuine content resolution policy saved.

The network user 560 with administrative authority may decide to view additional information as to the genuine content resolution policy capabilities and the threat against which it is being protected by clicking the “Learn More” link. Clicking the “Learn More” link may send the network user 560 with administrative authority to a “Learn More” webpage. In addition to the initial setup, the configuration webpage 400 may be used to modify the settings of the genuine content resolution policy.

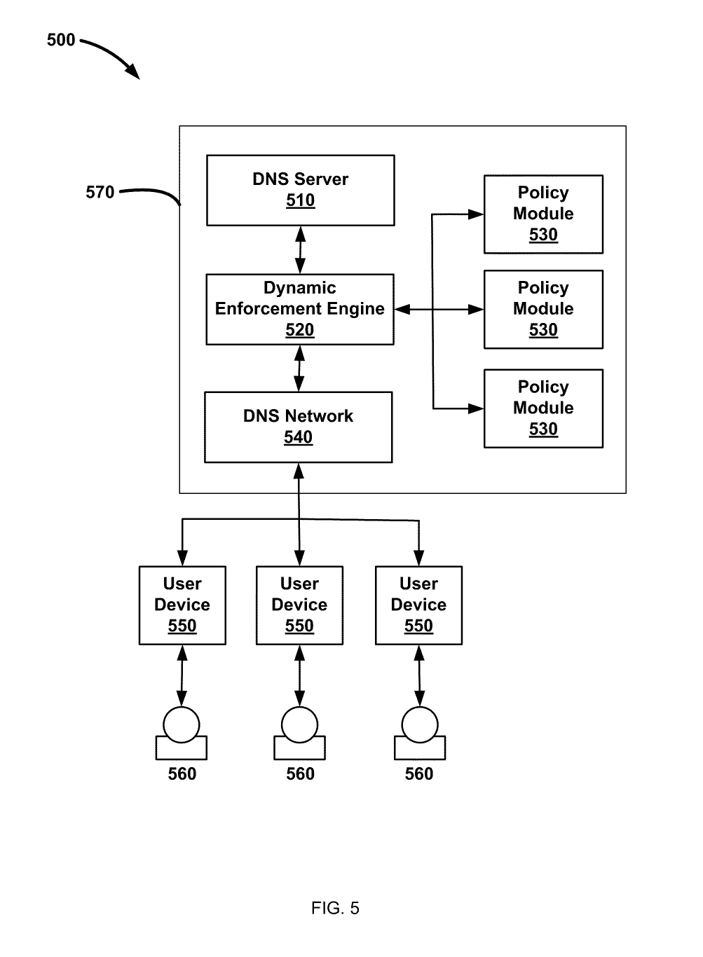

FIG. 5 illustrates an exemplary Internet service system 500, with a DNS Server, that may be utilized to support the above described systems and methods. A DNS Server 510 operates in conjunction with a dynamic enforcement engine 520. The dynamic enforcement engine 520 may operate in conjunction with one or more policy modules 530 to establish any applicable polices at the DNS Server 510 level. The content rules are applied to received user queries to determine which content the DNS network 540 delivers through various user devices 550 to the network users 560.

The dynamic enforcement engine 520 may generate its policy engine on instructions received from one or more policy modules 530. Each policy module 530 may be constructed to provide various types and levels of services to the DNS network 540. In various embodiments, a policy module 530 may be configured to handle queries directed to subjects including, but not limited to, malicious domain redirection, user access redirection, non-existent domain redirection, and data collection or analysis.

It will be recognized by those skilled in the art that the elements of DNS service 570 may be hosted either locally or remotely. In addition to residing in the DNS service 570, one or more of the DNS network 540, the dynamic enforcement engine 520, and the policy modules 530, and any combination thereof, may be resident on one or more user devices 550.

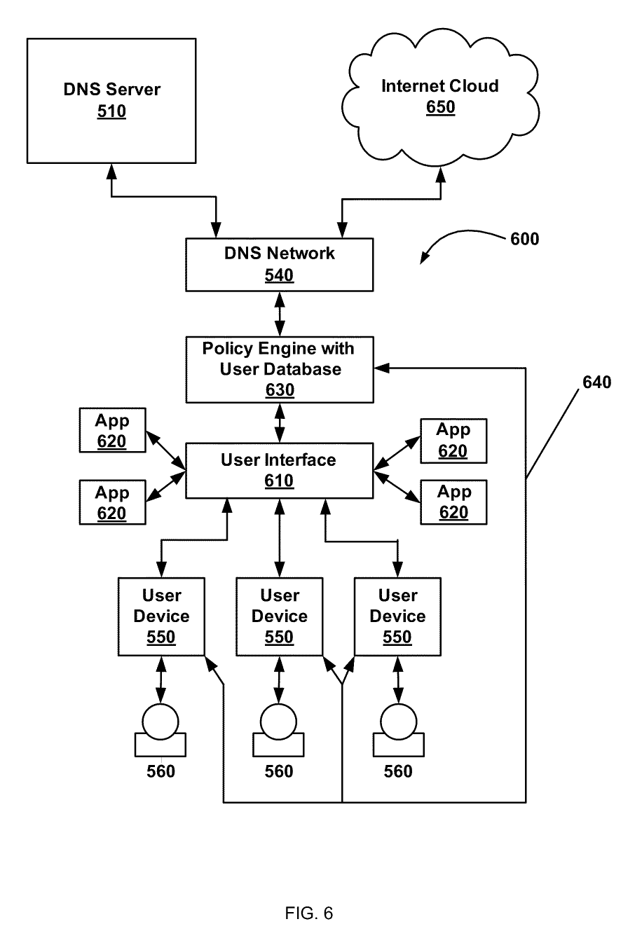

FIG. 6 shows a schematic layout of an exemplary system 600 for implementing direct and variable network user control. FIG. 6 illustrates that the system 600 may operate installed on a DNS Server 510, or with a cloud 650 based installation.

The system 600 utilizes a user interface 610. The user interface 610 may be implemented in many embodiments. One specific implementation of the user interface 610 is as a web page.

The user interface 610 may be accessed by one or more user devices 550 operated by the users 560. The user interface 610 may be accessed through a gateway user device 550 available to the users 560. Suitable user devices 550 include but are not limited to desktops, personal computers (PCs), laptops, notebooks, gaming devices, iPods, Smartphones, automobile computer systems, and Internet enabled televisions (TVs). The system 600 may also be accessed and controlled t remotely through user devices 550, such as Smartphones, mobile devices or other specialized Internet access devices such as a tablet. A Smartphone may be defined as a phone with computing capability. A Smartphone may provide the user 560 with Internet access.

The user interface 610 provides a mechanism for one or more authorized users 560 to establish content policy for the Internet service. The user interface 610 operates between the user devices 550 present in the system 600 and the DNS network 540. Instructions resident on the user interface 610 therefore operate on the Internet service, by controlling at least a portion of DNS resolutions via a dynamic policy engine 630, before the service reaches the displays of the user devices 550.

The user interface 610 provides the users 560 with access to one or more policy applications 620. The user interface 610 may provide access to a selection list to at least one authorized user 560. The authorized user 560 uses the selection list or some other menu mechanism to select those policy applications 620 that the user 560 chooses to apply to the system 600. The authorized user 560 may select any number of the available policy applications for use on the system 600 at any given time. In implementations utilizing Smartphones as the user device 550, the policy applications 620 are downloaded to the device 550. The device 550 then serves as the user interface 610 to communicate directly with the dynamic policy engine 630.

The policy applications 620 may prohibit access to specific Internet content. The policy applications 620 may also limit the time of day when users or selected users 560 may access certain Internet content. The policy applications 620 may also manage and analyze duration of access to various Internet content. It is important to note that the policy applications 620 do not simply provide blocking mechanisms by masking or enabling network controls, but rather mediate an Internet service received by the network user. As used herein, mediating the service may include any of blocking, constraining, enabling, redirecting, promoting, demoting, substituting, obscuring, limiting, interrupting, and restricting all or a portion of the Internet service. The policy applications 620 may provide notifications or alerts to one or more users 560 when Internet content is accessed. The policy applications 620 may also provide notification of frequency and duration of access of designated Internet content. The policy applications 620 may also be used to observe, substitute, enable, redirect users, to reward behavior desired from the users by a system administrator, and so forth. The policy applications 620 may redirect users from non-favored Internet content to different Internet content. The policy applications 620 may also collect and transmit data characteristic of Internet use.

Access policies supplied by the policy applications 620 may apply to all users 560 of the system 600, or the access policies may be specific to individual users or groups of users 560. The policy applications 620 may be discrete, single purpose applications.

The policy applications 620 provide the users 560 with a mechanism to take various actions relative to their Internet service feed. The policy applications 620 also allow the users 560 to establish a dynamic policy engine 630 that includes a user database. The dynamic policy engine 630 is used to enforce rules associated with each policy application associated with individual network users, rather than simply block various inappropriate Internet content from the Internet feed. Rather, the dynamic policy engine 630, controlled by the user interface 610 through user device(s) 550, is used to manage all aspects of the Internet experience for the users 560. In sum, the policy applications 620 may be used to configure the dynamic policy engine 630 to provide the users 560 with a mechanism to personalize the Internet experience. The policy applications 620 may be configured in combinations and may each be separately configured.

The database in the dynamic policy engine 630 may be used to record and to notify users 560 of various data relative to Internet access. The data collected from and provided to the users 560 may include records of access of specific Internet content, time spent on specific Internet content, time of day of access, data specific to individual users, and so forth.

It should also be noted that following an initial setup through the user interface 610 of the dynamic policy engine 630, a direct access 640 enforcement loop may be established between the policy engine 630 and the user devices 550. Subsequent accessing of the DNS network 540 utilizing the direct access 640 decreases response time in the system 600, thereby further enhancing the Internet experience of the users 560. Configurations of policy applications 620 that are selected by one or more users 560 designated as system administrators may remain in the user database of the dynamic policy engine 630 until such time as it may be modified by the system administrators. The system administrators may define multiple policy configurations, with a combination of policy applications 620, applicable to one or more network users 560 of the system 600. Each policy application 620 may also be separately configurable. Policy configurations may vary based upon designated times, conditional triggers, or specific requests from the users 560 with administrative authority.

As indicated above, two discrete data flow paths may be established for the system 600. A first data path establishes a set of enforcement policies for the system 500. The first data path flows from at least one user device 550 through the user interface 610 to the policy enforcement engine 630. A second data path 640 may be utilized following the establishment of a set of policies for the system 600. The second data path 640 flows directly between the user device(s) 550 and the policy engine 630. Multiple sets of enforcement policies may be established and saved within the system 600 and implemented selectively by the users 560.

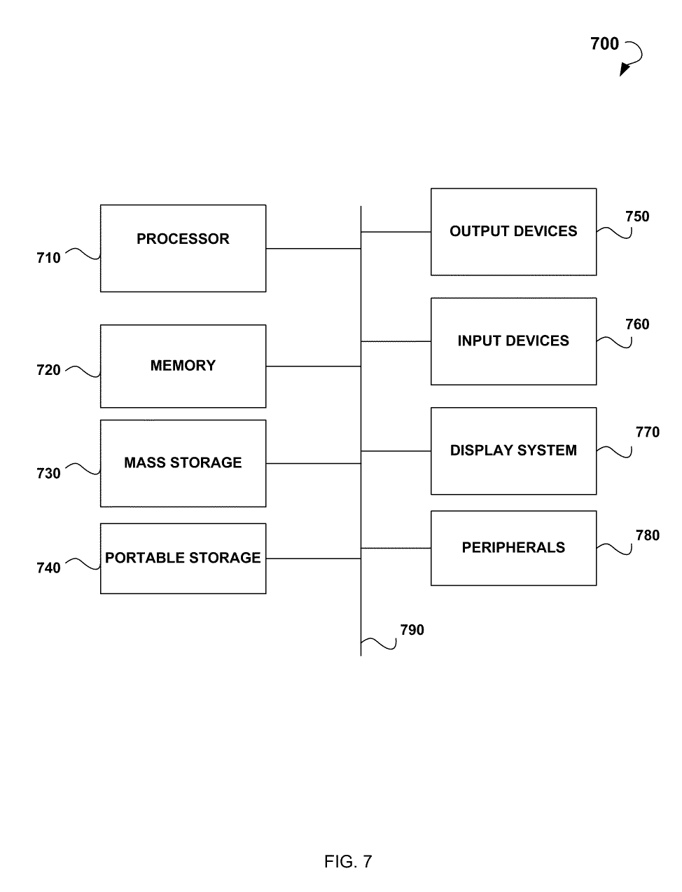

FIG. 7 illustrates an exemplary computing system 700 that may be used to implement an embodiment of the present invention. System 700 of FIG. 7 may be implemented in the context of user devices 550, DNS Server 510, Internet cloud 650 and the like. The computing system 700 of FIG. 7 includes one or more processors 710 and main memory 720. Main memory 720 stores, in part, instructions and data for execution by processor 710. Main memory 720 can store the executable code when the system 700 is in operation. The system 700 of FIG. 7 may further include a mass storage device 730, portable storage medium drive(s) 740, output devices 750, user input devices 760, a display system 770, and other peripheral devices 780.

The components shown in FIG. 7 are depicted as being connected via a single bus 790. The components may be connected through one or more data transport means. Processor 710 and main memory 720 may be connected via a local microprocessor bus, and the mass storage device 730, peripheral device(s) 780, portable storage medium drive 740, and display system 770 may be connected via one or more input/output (I/O) buses.

Mass storage device 730, which may be implemented with a magnetic disk drive or an optical disk drive, is a non-volatile storage device for storing data and instructions for use by processor 710. Mass storage device 730 can store the system software for implementing embodiments of the present invention for purposes of loading that software into main memory 720.

Portable storage medium drive 740 operates in conjunction with a portable non-volatile storage medium, such as a floppy disk, compact disk (CD) or digital video disc (DVD), to input and output data and code to and from the computer system 700 of FIG. 7. The system software for implementing embodiments of the present invention may be stored on such a portable medium and input to the computer system 700 via the portable storage medium drive 740.

Input devices 760 provide a portion of a user interface. Input devices 760 may include an alpha-numeric keypad, such as a keyboard, for inputting alpha-numeric and other information, or a pointing device, such as a mouse, a trackball, stylus, or cursor direction keys. Additionally, the system 700 as shown in FIG. 7 includes output devices 750. Suitable output devices include speakers, printers, network interfaces, and monitors.

Display system 770 may include a liquid crystal display (LCD) or other suitable display device. Display system 770 receives textual and graphical information and processes the information for output to the display device.

Peripherals 780 may include any type of computer support device to add additional functionality to the computer system. Peripheral device(s) 780 may include a modem or a router.

The components contained in the computer system 700 of FIG. 7 are those typically found in computer systems that may be suitable for use with embodiments of the present invention and are intended to represent a broad category of such computer components that are well known in the art. Thus, the computer system 700 of FIG. 7 can be a PC, hand held computing device, telephone, mobile computing device, workstation, server, minicomputer, mainframe computer, or any other computing device. The computer can also include different bus configurations, networked platforms, multi-processor platforms, and so forth. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire, and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, DVD, any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. While the present invention has been described in connection with a series of embodiments, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art. For example, this description describes the technology in the context of an Internet service in conjunction with a DNS server. It will be appreciated by those skilled in the art that functionalities and method steps that are performed by a DNS server may be performed by an Internet service and vice versa.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the invention as described herein.

One skilled in the art will further appreciate that the term “Internet content” encompasses any content that may be accessed by an Internet access user device and may include but not be limited to one or more of web sites, domains, web pages, web addresses, hyperlinks, URLs, any text, pictures, and/or media (such as video, audio, and any combination of audio and video) provided or displayed on a web page, and any combination thereof. A content resolution policy may include any of blocking, constraining, enabling, redirecting, promoting, demoting, substituting, obscuring, limiting, and interrupting.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or subcombinations. Each of these processes or steps may be implemented in a variety of different ways. Also, while processes or steps are at times shown as being performed in series, these processes or steps may instead be performed in parallel, or may be performed at different times.

From the foregoing, it will be appreciated that specific embodiments of the system have been described herein for purposes of illustration, but that various modifications may be made without deviating from the spirit and scope of the system. Accordingly, the disclosure is not limited except as by the appended claims.

What is claimed is:

1. A method for redirecting requests for Internet content to an intended destination, the method comprising:
utilizing a user interface between a network user with administrative authority and an Internet service to establish a content resolution policy; and
applying the content resolution policy to a request of a user of the network to access an Internet site, a policy enforcement module determining whether or not the content resolution policy indicates that the user is to be directed to an Internet site that contains Internet content of the requested Internet site.

2. The method of claim 1, wherein a mistyped Internet site in the user request causes the Internet service to be redirected to an intended Internet site.

3. The method of claim 1, wherein the policy enforcement module determines a user has activated an erroneous Internet site and redirects the request to the correct Internet content.

4. The method of claim 1, wherein the policy enforcement module redirects only valid Internet sites.

5. The method of claim 1, wherein at least one element of the content resolution policy resides on a DNS server.

6. The method of claim 1, wherein at least one element of the content resolution policy is enforced by the DNS server.

7. The method of claim 1, wherein the user interface provides a mechanism for activating and deactivating the content resolution policy.

8. The method of claim 1, further comprising the policy enforcement module maintaining a substitution list of Internet sites for substitution in requests for similar Internet sites.

9. The method of claim 8, wherein the list of Internet sites for substitution is produced by analyzing a degree of error from intended site names and determining an appropriate substitute.

10. The method of claim 8, wherein each Internet site on the substitution list is assigned a confidence score to assist in determining the intended Internet site.

11. The method of claim 8, wherein the substitution list is pre-populated with Internet sites of trademarks.

12. The method of claim 8, wherein the creation of the substitution list includes applying user specific contextual data to determine the appropriate intended Internet site.

13. The method of claim 1, further comprising compiling data related to the content resolution policy in a reporting log, the data including the intended Internet site, a number of requests to access the intended Internet site, and the intended Internet site corresponding to the intended Internet site.

14. The method of claim 10, wherein parameters associated with the confidence score are accessible by the network user with administrative authority through the Internet service.

15. The method of claim 1, further comprising:
determining that the content resolution policy is activated;
determining that the requested Internet site is not the intended Internet site; and
based on the determination, selectively providing the intended Internet site.

16. The method of claim 1, wherein the network user with administrative authority specifies different content resolution policies for different locations.

17. The method of claim 1, wherein the determination as to whether or not the request is for intended Internet site is based on registration or ownership of the requested Internet site.

18. The method of claim 1, wherein the policy enforcement module causes the Internet service to directly navigate the user to the intended Internet site.

19. The method of claim 1, wherein the policy enforcement module requests confirmation from the user before directing the user to a substituted Internet site.

20. The method of claim 19, wherein a determination to initiate a confirmation message is based on the confidence score.

21. The method of claim 19, wherein the Internet service updates the confidence score based on user input.

22. The method of claim 1, wherein the policy enforcement module determines if the request is for an Internet site contains malicious content, and if so, redirects the request.

23. The method of claim 1, wherein the content resolution policy is dynamically updated based on feedback from the Internet service.

24. The method of claim 1, wherein at least one element of the Internet service resides on a user device.

25. The method of claim 1, wherein the user with administrative authority sets different content resolution policies for different locations.

26. The method of claim 1, wherein the content resolution policy is created by a collaborative effort from more than one user.

27. The method of claim 26, wherein at least one user is not a user of the network to which the content resolution policy is applied.

28. A system for redirection of online queries to an intended Internet content, comprising:
a user interface module to provide a user interface between a network user with administrative authority and an Internet service;
a communication module to receive from the network user with administrative authority, via the user interface, a request to establish a content resolution policy for a network;
a policy generating module to generate the content resolution policy for the network; and
a policy enforcement module to apply the content resolution policy to a user request to access a requested Internet site, the policy enforcement module determining whether or not the content resolution policy is in effect to provide an intended Internet site instead of the requested Internet site.

29. The system of claim 28, further comprising a policy activation module to activate and deactivate the content resolution policy.

30. The system of claim 28, wherein the policy enforcement module maintains a list of frequently accessed Internet sites.

31. The system of claim 30, wherein the content resolution policy is based on the list of frequently accessed Internet sites.

32. The system of claim 31, wherein the intended Internet site is one of the frequently accessed Internet sites.

33. The system of claim 28, further comprising an information module to compile data related to the content resolution policy in a reporting log, the data including the requested Internet site, a number of requests to access the requested Internet site, and the intended Internet site corresponding to the requested Internet site.

34. The system of claim 28, wherein the policy enforcement module performs the steps of:
determining that the content resolution policy is activated;
determining whether or not the requested Internet site is the intended Internet site; and
selectively providing the intended Internet site.

35. The system of claim 28, wherein the determination as to whether or not the requested Internet site is the intended Internet site is based on one or more spelling mistakes in the requested Internet site.

36. The system of claim 28, wherein the determination as to whether or not the requested Internet site is the intended Internet site is based on an ownership of the requested website.

37. The system of claim 28, wherein a mistyped Internet site in the user request causes the Internet service to be redirected to an intended Internet site.

38. The system of claim 28, wherein at least one element of the content resolution policy resides on a DNS server.

39. The system of claim 28, wherein at least one element of the content resolution policy is enforced by the DNS server.

40. The system of claim 28, wherein each Internet site on the substitution list is assigned a confidence score to assist in determining the intended Internet site.

41. The system of claim 28, wherein the list of Internet sites for substitution is produced by analyzing a degree of error from requested Internet sites and determining an appropriate substitute.

42. The system of claim 28, wherein the content resolution policy is created by a collaborative effort from more than one user.

43. The system of claim 42, wherein at least one user is not a user of the network to which the content resolution policy is applied.

44. A non-transitory computer readable storage medium having a program embodied thereon, the program executable by a processor in a computing device to perform a method for redirection of online queries to content, the method comprising:
utilizing a user interface between a network user with administrative authority and an Internet service;
receiving from the network user, via the user interface, a request to establish a content resolution policy; and
applying the content resolution policy to a user request to access an intended Internet site, a policy enforcement module determining whether or not the content resolution policy is in effect to provide a intended Internet site instead of the requested Internet site.

45. A method for redirecting requests for Internet content to an intended destination, the method comprising:
utilizing a user interface between a network user with administrative authority and a DNS server to establish a content resolution policy; and
applying the content resolution policy to a request of a user of the network to access an Internet site, a policy enforcement module in the DNS server determining whether or not the content resolution policy indicates that the user is to be directed to an Internet site that contains Internet content of the requested Internet site.

46. The method of claim 45, wherein a mistyped site in the user request causes the DNS server to redirect to an intended Internet site.

47. The method of claim 45, wherein the policy enforcement module in the DNS server determines a user has activated an erroneous Internet site and redirects the request to the correct Internet content.

48. The method of claim 45, wherein the policy enforcement module in the DNS server redirects active to Internet sites.

49. The method of claim 45, wherein the user interface provides a mechanism for activating and deactivating the content resolution policy.

50. The method of claim 45, further comprising the policy enforcement module in the DNS server maintaining a substitution list of Internet sites for substitution in requests for similar sites or addresses.

51. The method of claim 50, wherein the list of Internet sites for substitution is produced by analyzing a degree of error from the requested Internet sites and determining an appropriate substitute.

52. The method of claim 50, wherein each Internet site on the substitution list is assigned a confidence score to assist in determining the intended Internet site.

53. The method of claim 50, wherein the substitution list is pre-populated in the DNS server with Internet sites of trademarks.

54. The method of claim 50, wherein the creation of the substitution list in the DNS server includes applying user specific contextual data to determine the appropriate intended Internet site.

55. The method of claim 45, further comprising compiling data related to the content resolution policy in a reporting log, the data including the intended Internet site, a number of requests to access the intended Internet site, and the intended Internet site corresponding to the intended Internet site.

56. The method of claim 52, wherein parameters associated with the confidence score are accessible by the network user with administrative authority through the Internet service.

57. The method of claim 45, further comprising:
determining that the content resolution policy is activated;
determining that the requested Internet site is not the intend Internet site with the requested Internet content; and
based on the determination, selectively providing the intended Internet site.

58. The method of claim 45, wherein the determination as to whether or not the request is for the intended Internet site is based on registration or ownership of the requested Internet site.

59. The method of claim 45, wherein the policy enforcement module in the DNS server causes the Internet service to directly navigate the user to the intended Internet site.

60. The method of claim 45, wherein the policy enforcement module in the DNS server initiates a confirmation message before directing the user to a substituted Internet site.

61. The method of claim 60, wherein a determination to initiate a confirmation message is based on a confidence score.

62. The method of claim 61, wherein the Internet service updates the confidence score based on user input.

63. The method of claim 45, wherein the policy enforcement module in the DNS server determines if the request Internet site contains malicious content, and if so, redirects the request.

64. The method of claim 45, wherein the content resolution policy in the DNS server is dynamically updated based on feedback from the Internet service.

65. The method of claim 45, wherein at least one element of the Internet service resides on a user device.

66. The method of claim 45, wherein the user with administrative authority sets different content resolution policies for different locations.

67. The method of claim 45, wherein the content resolution policy is created by a collaborative effort from more than one user.

68. The method of claim 67, wherein at least one user is not a user of the network to which the content resolution policy is applied.

69. A system for redirection of online queries to an intended Internet content, comprising:
a user interface module to provide a user interface between a network user with administrative authority and a DNS server;
a communication module to receive from the network user with administrative authority, via the user interface, a request to establish a content resolution policy for a network;
a policy generating module to generate the content resolution policy for the network; and
a policy enforcement module to apply the content resolution policy to a user request to access a requested Internet site, the policy enforcement module determining whether or not the content resolution policy is in effect to provide an intended Internet site instead of the requested Internet site.

70. The system of claim 69, further comprising a policy activation module to activate and deactivate the content resolution policy.

71. The system of claim 69, wherein the policy enforcement module maintains a list of frequently accessed Internet sites.

72. The system of claim 71, wherein the content resolution policy is based on the list of frequently accessed Internet sites.

73. The system of claim 72, wherein the intended Internet site is one of the frequently accessed Internet sites.

74. The system of claim 69, further comprising an information module to compile data related to the content resolution policy in a reporting log, the data including the requested Internet site, a number of requests to access the requested Internet site, and the intended Internet site corresponding to the requested Internet site.

75. The system of claim 69, wherein the policy enforcement module performs the steps of:
determining that the content resolution policy is activated;
determining whether or not the requested Internet site is the intended Internet site; and
selectively providing the intended Internet site.

76. The system of claim 69, wherein the determination as to whether or not the requested Internet site is the intended Internet site is based on one or more spelling mistakes in the requested Internet site.

77. The system of claim 69, wherein the determination as to whether or not the requested Internet site is the intended website is based on an ownership of the requested website.

78. The system of claim 69, wherein a mistyped Internet site in the user request causes the Internet service to be redirected to an intended Internet site.

79. The system of claim 69, wherein at least one element of the Internet service resides on a user device.

80. The system of claim 69, wherein the administrator sets different content resolution policies for different locations.

81. The system of claim 69, wherein each Internet site on the substitution list is assigned a confidence score to determine the Internet site

82. The system of claim 69, wherein the list of Internet sites for substitution is produced by analyzing a degree of error from requested Internet sites and determining an appropriate substitute.

83. The system of claim 69, wherein the content resolution policy is created by a collaborative effort from more than one user.

84. The system of claim 83, wherein at least one user is not a user of the network to which the content resolution policy is applied.
